(19) United States
(12) Patent Application Publication
(10) Pub. No.: US 2024/0060437 A1
(43) Pub. Date: Feb. 22, 2024

(54) EXHAUST GAS COOLING DEVICE

(71) Applicant: TENNECO GMBH, Edenkoben (DE)

(72) Inventors: Markus SCHUSTER, Edenkoben (DE); Philipp GRAN, Edenkoben (DE); Peter RÄSCH, Edenkoben (DE)

(21) Appl. No.: 18/037,420

(22) PCT Filed: Nov. 24, 2021
(86) PCT No.: PCT/EP2021/082769

§ 371 Date: May 17, 2023

(30) Foreign Application Priority Data
Nov. 24, 2020 (DE) 10 2020 131 039.0

(51) Int. Cl. F01N 3/05; F01N 13/08

(52) U.S. Cl. CPC F01N 3/05; F01N 13/082; F01N 2410/00; F01N 2470/30; F01N 2470/20

(57) ABSTRACT

The disclosure relates to an exhaust gas cooling device for an internal combustion engine, having a housing which can be connected to an exhaust gas line of the internal combustion engine and has an axis of symmetry and having a Venturi assembly coupled to the housing for introducing exhaust gas and ambient air and having an outlet line emitting an exhaust gas-ambient air mixture into the environment, wherein: the Venturi assembly has a Venturi channel which can be coupled fluidically to the exhaust gas line and an inlet opening delimited by the Venturi channel and the exhaust gas line for ambient air; the Venturi channel is used to conduct an exhaust gas-ambient air mixture and opens, with the inlet opening, into a mixing chamber; the Venturi channel has an outlet opening and the outlet opening has an inflow opening, wherein the outlet opening and the inflow opening are spaced apart from one another; the Venturi channel and the outlet line, with the inflow opening, open into the housing.

### CROSS-REFERENCE TO RELATED APPLICATIONS

This application is a U.S. National Phase application under 35 U.S.C. 371 of International Application No. PCT/EP2021/082769, filed on Nov. 24, 2021, which claims the benefit of German Patent Application No. 10 2020 131 039.0, filed on Nov. 24, 2020, of which the entire disclosure is incorporated herein by reference.

### FIELD

The disclosure relates to an exhaust gas cooling device for a hot gas source, such as an internal combustion engine or a fuel cell, with a housing with an axis of symmetry connectable to an exhaust gas line of the internal combustion engine or the cell and with a venturi assembly coupled to the housing for introducing exhaust gas and ambient air and with an outlet line emitting exhaust gas/ambient air mixture into the environment, wherein the venturi assembly has a venturi channel connectable fluidically to the exhaust gas line and an inlet opening for ambient air delimited by the venturi channel and the exhaust gas line, wherein the venturi channel is used for guiding the exhaust gas/ambient air mixture and opens with the inlet opening into a mixing chamber.

### BACKGROUND

This section provides background information related to the present disclosure which is not necessarily prior art.

An exhaust gas cooling device is already known from U.S. Pat. No. 8,549,850 B2 with a venturi arrangement for supplying ambient air. The exhaust gas cooling device has a plurality of exhaust gas inlet channels and a downstream venturi duct. In addition, a plurality of inlet openings for ambient air are provided. The exhaust gas and the ambient air taken in are mixed via the venturi duct and transferred to the environment.

### SUMMARY

This section provides a general summary of the disclosure, and is not a comprehensive disclosure of its full scope or all of its features.

It is the object of the disclosure to configure and arrange an exhaust gas cooling device in such a way that an improved mixing of the exhaust gas-ambient air mixture is ensured.

The object is achieved according to the disclosure in that the venturi channel has an outlet opening and the outlet line has an inflow opening, wherein the outlet opening and the inflow opening are spaced apart from one another, wherein the venturi channel and the outlet line open with their inflow opening into the housing. The outlet line is used for guiding the exhaust gas/ambient air mixture from inside the housing into a further exhaust gas line or into the environment. In this way it is achieved that the exhaust gas/ambient air mixture is guided for a longer period and over a longer path inside the housing, whereby the mixing is improved before the exhaust gas/ambient air mixture is guided via the outlet line into the environment.

To this end, it can also be advantageous if the housing delimits the mixing chamber with a chamber wall, wherein the outlet opening of the venturi channel has an outlet cross-section Qv and the mixing chamber for the exhaust gas/ambient air mixture exiting the venturi channel forms a flow cross-section Qm, with Qm>=f Qv, with 2<=f<=12, in particular with f=6, f=7 or f=8. With the widening of the flow cross-section when entering the housing or the mixing chamber the flow velocity is reduced, which is accompanied by a longer dwelling time in the housing.

Furthermore, it can be advantageous if the outlet opening of the venturi channel and the inflow opening of the outlet line are arranged out of an alignment. By means of this non-aligned arrangement or the offset achieved by various alignments of the openings, the distance to be traveled by the exhaust gas/ambient air mixture inside the housing is increased. The alignment or offset or orientation relates to the respective central axis of the outlet opening and inflow opening or the flow vector defined by the respective central axis, such as gas outlet A and gas inlet E. Non-alignment can also be achieved in that the flow vectors have different orientations.

It can also be advantageous if the outlet opening of the venturi channel and the inflow opening of the outlet line are positioned in alignment, wherein a deflector element is provided between the outlet opening and the inflow opening, which effects a deflection in a direction Rq with a directional component at right angles to the direction of the gas outlet A of the outlet opening. This is also accompanied by an increased flow path inside the mixing chamber despite the aforementioned alignment.

It can be provided advantageously that the outlet opening of the venturi channel effects a gas-outlet A directed in radial direction to the axis of symmetry, wherein the outlet line with the inflow opening effects a gas inlet E directed parallel to the axis of symmetry. This ensures at least a 90° deflection of the gas flow and the associated increased flow path.

It may be of particular importance for the present disclosure if the mixing chamber at least partially has a round cross-sectional shape Q with respect to the axis of symmetry or if vortexing means are provided on the chamber wall, wherein the gas outlet A effects at least one double vortex in the mixing chamber, directed in opposite direction with respect to the axis of symmetry, when the gas flow impinges on the round chamber wall or on the vortexing means. The at least one double vortex also lengthens the flow path and thus the dwelling time. The round shape of the chamber wall can include circular, oval or other round shapes. The fin or wing-shaped vortexing means may also be formed by the chamber wall or be an integral part of the chamber wall. A square cross-sectional shape Q of the mixing chamber is also possible, if corresponding vortexing means are provided on the chamber wall.

In connection with the configuration and arrangement according to the disclosure it may be advantageous if the venturi channel forms a mixing stage My with a volume Vv and if the mixing chamber forms a mixing stage Mm with a volume Vm and if the outlet line forms a mixing stage Ma with a volume Va, wherein for the ratio S1 of Vm to Vv: 25>=S1>=2, in particular 16>=S1>=12 and/or for the ratio S2 of Vm to Va: 25>=S2>=2, in particular 16>=S2>=12. The relative size of the mixing chamber is also decisive for the length of the obtainable flow paths of the gas flow inside the otherwise closed mixing chamber. A relatively large mixing chamber ensures relatively large or long flow paths.

It can also be advantageous if sound-absorbing means are provided inside the mixing chamber and/or upstream of the venturi assembly.

In addition, it can be advantageous if further vortexing or deflecting means are provided inside the mixing chamber. In this way the mixing is further improved.

In addition, it can be advantageous if a baffle is provided upstream of the inlet opening for ambient air or at the ambient air inlet for trapping ambient air or airflow in order to actively increase the amount of ambient air supplied.

The ambient air can also be supplied directly via the inlet opening for ambient air. In this case, the inlet opening opens to the environment. There is no need for an ambient air inlet that would have to be routed through the housing.

Furthermore, it can be advantageous if a bypass arrangement with a bypass line is provided, via which the exhaust gas can be guided past the cooling device.

Furthermore, it can be advantageous if the venturi channel and the outlet line with the inflow opening open into the same mixing chamber of the housing. The cooling of the exhaust gas/ambient air mixture takes place in the mixing chamber, in particular by transferring heat to the chamber wall. The exhaust gas/ambient air mixture can be guided immediately after cooling or flowing through the mixing chamber via the inflow opening of the outlet line out of the mixing chamber.

For this purpose, it can be advantageous if the mixing chamber is free of partition walls or housing-partition walls. This ensures an optimal flow of the exhaust gas/ambient air mixture inside the one mixing chamber. A loss of pressure associated with a partition wall or housing-partition wall is avoided. Partition walls or housing-partition walls are considered to be walls inside the mixing chamber which are provided with one or more through openings or perforations. Such walls divide the mixing chamber into two partial-mixing chambers in flow communication.

For this purpose, it can be advantageous if the inlet opening is coupled to the environment via an ambient air channel and an ambient air inlet guided through the housing, wherein the ambient air inlet is aligned in a radial direction to the axis of symmetry. Thus, the inflowing ambient air experiences a radial directional component which can be deflected by the cylindrical ambient air channel at least partially in circumferential direction to the axis of symmetry. The ambient air thus experiences directional components in circumferential direction and in axial direction to the axis of symmetry. This ensures a first mixing of exhaust gas and ambient air in the venturi channel.

Further areas of applicability will become apparent from the description provided herein. The description and specific examples in this summary are intended for purposes of illustration only and are not intended to limit the scope of the pre-sent disclosure.

### DRAWINGS

The drawings described herein are for illustrative purposes only of selected embodiments and not all possible implementations, and are not intended to limit the scope of the present disclosure.

Further advantages and details of the disclosure are explained in the claims and in the description and shown in the figures. In the drawings:

FIG. 1a shows a sectional view B-B from FIG. 2;

FIG. 1b shows a sectional view of an alternative embodiment;

FIG. 2 shows a sectional view A-A from FIG. 3;

FIG. 3 shows a schematic sketch;

FIG. 4 shows various cross-sectional forms;

FIG. 5 shows a schematic sketch of a further embodiment.

Corresponding reference numerals indicate corresponding parts throughout the several views of the drawings.

### DETAILED DESCRIPTION

Example embodiments will now be described more fully with reference to the accompanying drawings.

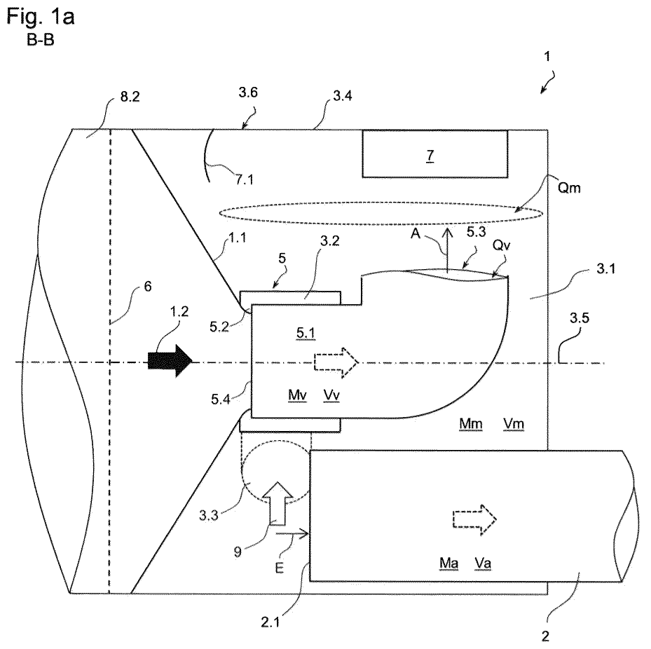

An exhaust gas cooling device 1 shown in FIG. 1a in sectional view B-B is coupled to an exhaust gas line 1.1 for exhaust gas 1.2. The exhaust gas line 1.1 is an outlet pipe of an exhaust gas purification system 8.2, such as a catalytic converter housing. The exhaust gas cooling device 1 has a housing 3.6 with a chamber wall 3.4 which delimit a mixing chamber 3.1. Inside the housing 3.6 a venturi assembly 5 is provided with a venturi channel 5.1, which is fluidically coupled to the exhaust gas line 1.1 via an inlet opening 5.4 for exhaust gas, i.e. is blown on. In addition, the venturi-assembly 5 has an inlet opening 5.2 for ambient air 9, which is delimited by the exhaust gas line 1.1 on the one hand and the venturi channel 5.1 on the other hand. The inlet opening 5.2 for ambient air 9 is connected to an ambient air channel 3.2, which circumferentially surrounds the venturi channel 5.1. The ambient air channel 3.2 is in turn coupled to the environment via an air inlet 3.3. guided through the housing 3.6, so that the ambient air 9 is guided to the inlet opening 5.2 via the ambient air inlet 3.3 and the ambient air channel 3.2. The ambient air inlet 3.3 can have a baffle, not shown here, for capturing ambient air.

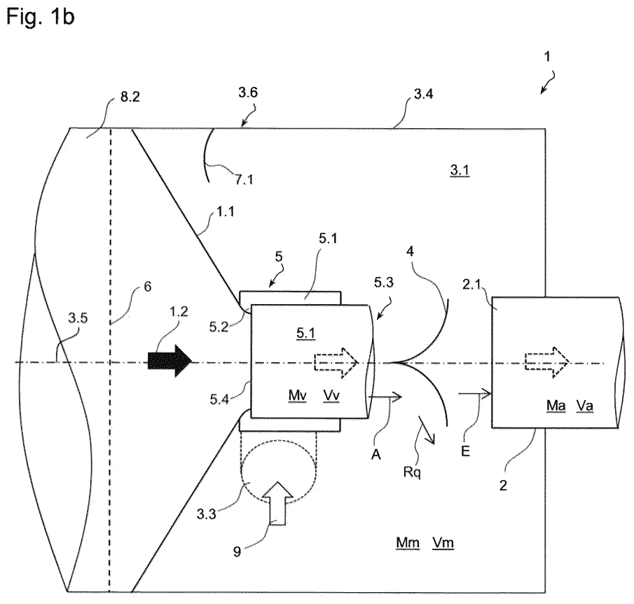

The venturi channel 5.1 thus guides the exhaust gas/ambient air mixture in the direction of an axis of symmetry 3.5 of the housing 3.6 or the mixing chamber 3.1, wherein the venturi channel 5.1 has a 90° bend at the end, so that a gas outlet A is achieved in radial direction to the axis of symmetry 3.5 via an outlet opening 5.3 of the venturi channel 5.1. As shown in FIG. 2, the exhaust gas/ambient air mixture exiting the outlet opening 5.3 meets the upper chamber wall 3.4 or a vortexing means 7 provided there, so that a counter-directed double vortex of the exhaust gas/ambient air mixture is formed due to the round cross-sectional shape Q shown in FIG. 2.

The housing 3.6 also has an outlet line 2 with an inflow opening 2.1, through which the exhaust gas/ambient air mixture is guided out of the housing 3.6 or the mixing chamber 3.1 outwardly or into the environment. The inflow opening 2.1 ensures that the gas-inlet E of the exhaust gas/ambient air mixture runs in axial direction. By means of the non-aligned or different and offset orientation of gas outlet A and gas inlet E a suitably long flow path is ensured inside the mixing chamber 3.1. The outlet opening 5.3 of the venturi channel hereby has an outlet cross-section Qv which is significantly smaller than a flow cross-section Qm, which is made available to the exhaust gas/ambient air mixture through the mixing chamber 3.1. This results in a corresponding delay of the flow velocity of the exhaust gas/ambient air mixture and thus an increased dwelling time inside the mixing chamber 3.1.

Inside the mixing chamber 3.1 a further deflector 7.1 is also provided for deflecting the gas flow on the way to the inflow opening 2.1. Upstream of the venturi assembly 5 an sound-absorbing means 6 is provided which the exhaust gas 1.2 hits immediately after leaving an exhaust gas purification system 8.2.

The exhaust gas cooling device 1 has a total of three mixing stages, the mixing stage Mv of the venturi channel 5.1 with a volume Vv, the mixing stage Mm of the mixing chamber 3.1 with a volume Vm and the mixing stage Ma of the outlet line 2 with a volume Va. Here the volume Vm of the mixing stage Mm is larger by a factor S1, S2 of 14 than the volume Vv, Va of the two other mixing stages Mv, Ma.

In the exemplary embodiment according to FIG. 1b, the gas outlet A and the gas inlet E have the same orientation. Furthermore, the outlet opening 5.3 of the venturi channel and the inflow opening 2.1 of the outlet line 2 are oriented in an alignment. To avoid the direct blowing of the inflow opening 2.1 through the venturi channel 5.1, a deflector element 4 is provided, via which the gas flow is directed radially outwards into the mixing chamber 3.1, in order to complete a sufficiently long flow path there to ensure the desired mixing of the exhaust gas/ambient air mixture. The gas outlet A is deflected by the deflector element 4 in a direction Rq with a directional component radial to the axis of symmetry 3.5.

According to the exemplary embodiments in FIGS. 1a, 1b the mixing chamber 3.1 is free of partition walls or housing-partition walls. In an alternative, not shown exemplary embodiment, the mixing chamber 3.1 can have at least one partition wall or one housing-partition wall, which is provided with one or more through openings or perforations. Thus, the mixing chamber is divided into two partial mixing chambers in flow connection.

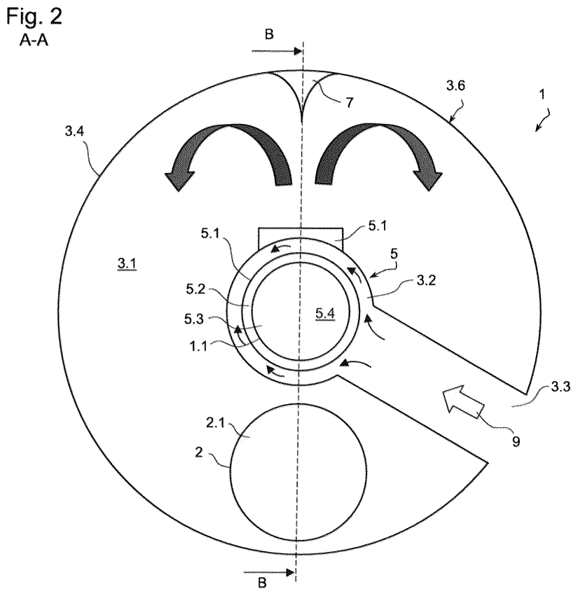

FIG. 3 shows the exhaust gas cooling device 1 downstream of an exhaust gas purification system 8.2. The exhaust gas purification system 8.2 is in turn connected to an internal combustion engine 8 via an exhaust gas line section 8.1. The exhaust gas 1.2 cooled to this extent leaves the exhaust system via the outlet line 2.

FIG. 2 shows the cross-sectional view A-A from FIG. 3. It also shows section B-B for the exemplary embodiment according to FIG. 1a.

The ambient air 9 is guided via the ambient air inlet 3.3 to the ambient air channel 3.2, which surrounds the venturi channel 5.1 circumferentially so that the ambient air 9 can enter the venturi channel 5.1 via the inlet opening 5.2 between the venturi-channel 5.1 and the exhaust gas line 1.1. The exhaust gas/ambient air mixture then leaves the venturi duct 5.1 radially upwards and reaches the concave chamber wall 3.4 or the vortexing means 7 placed there optionally so that a counter-directed double vortex is formed which in turn ensures a corresponding flow path of the exhaust gas/ambient air mixture inside the mixing chamber 3.1, before the exhaust gas/ambient air mixture is discharged outwards or to the environment via the inflow opening 2.1 of the outlet line 2.

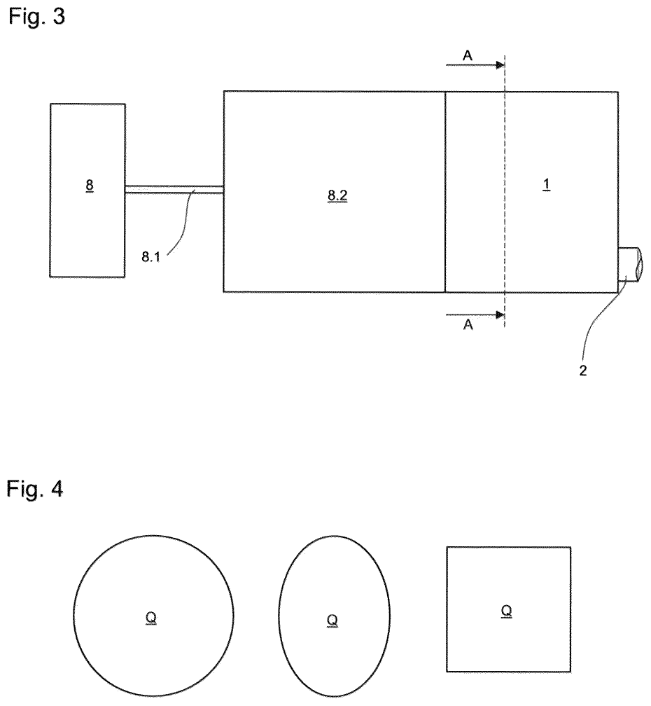

The aforementioned concave shape of the chamber wall 3.4 in the region in which the exhaust gas/ambient air mixture from the venturi channel 5.1 impinges on the chamber wall 3.4 ensures the formation of a double vortex. A concave shape is achieved by a correspondingly round or oval cross-sectional shape Q of the chamber wall 3.4, as depicted in FIG. 4. Of course, other cross-sectional forms are also possible, which ensure a corresponding formation of a double or single vortex when the gas flow impinges, so that the whole flow path, i.e. the dwelling time of the gas flow inside the mixing chamber 3.1, is increased. A square cross-sectional shape Q as also shown in FIG. 4 requires corresponding vortexing means on the chamber wall.

The inlet opening 5.2 is coupled to the environment or ambient air 9 via an ambient air channel 3.2 and an air inlet 3.3 guided through the housing 3.6. The ambient air inlet 3.3 is aligned in radial direction to the axis of symmetry 3.5. It is at least partially deflected by the cylindrical ambient air duct 3.2 in circumferential direction to the axis of symmetry 3.5 and enters the inlet opening 5.2 for ambient air 9 at least with a directional component in axial direction to the axis of symmetry 3.5 or parallel to the exhaust gas 1.2.

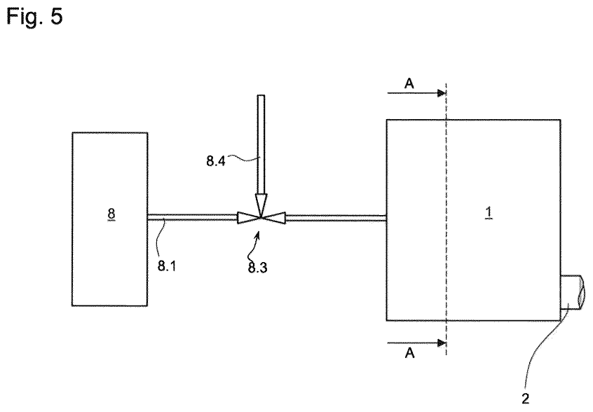

The embodiment of the exhaust gas cooling device 1 shown in FIG. 5 is arranged directly downstream of a hot gas source 8 such as an internal combustion engine or a fuel cell. In addition, the exhaust gas cooling device 1 has a bypass arrangement 8.3 with a bypass line 8.4, via which the exhaust gas can be guided past the exhaust gas cooling device 1.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. An exhaust gas cooling device for a hot gas source with a housing with an axis of symmetry connectable to an exhaust gas line of the hot gas source and with a venturi assembly coupled to the housing for introducing exhaust gas and ambient air and with an outlet line discharging an exhaust gas/ambient air mixture into the environment, wherein the venturi assembly has a venturi channel which can be coupled fluidically to the exhaust gas line and an inlet opening for ambient air which is delimited by the venturi channel and the exhaust gas line, wherein the venturi channel is used for guiding the exhaust gas/ambient air mixture and with the inlet opening opens into a mixing chamber,
wherein
the venturi channel has an outlet opening and the outlet line has an inflow opening, wherein the outlet opening and the inflow opening are spaced apart from one another, wherein the venturi channel and the outlet line open with the inflow opening into the housing.

2. The exhaust gas cooling device according to claim 1,
wherein
the housing delimits the mixing chamber with a chamber wall, wherein the outlet opening of the venturi channel has an outlet cross-section Qv and the mixing chamber for the exhaust gas/ambient air mixture emerging from the venturi channel forms a flow cross-section Qm with >=f Qv, with 2<=f<=10.

3. The exhaust gas cooling device according to claim 1,
wherein
the outlet opening of the venturi channel and the inflow opening of the outlet line are arranged outside of an alignment.

4. The exhaust gas cooling device according to claim 1,
wherein
the outlet opening of the venturi channel and the inflow opening of the outlet line are positioned in an alignment, wherein a deflector element is provided between the outlet opening and the inflow opening, which brings about a deflection in a direction Rq with a direction component at right angles to the direction of the gas outlet A of the outlet opening.

5. The exhaust gas cooling device according to claim 1,
wherein
the outlet opening of the venturi channel effects a gas outlet A directed in radial direction to the axis of symmetry, wherein the outlet line with the inflow opening effects a gas inlet E directed parallel to the axis of symmetry.

6. The exhaust gas cooling device according to claim 1,
wherein
the mixing chamber at least partially has a round cross-sectional shape with respect to the axis of symmetry or vortexing means are provided on the chamber wall, wherein the gas outlet A, when the gas stream impinges on the round chamber wall or on the vortexing means, effects at least one double vortex in the mixing chamber which is directed in opposite direction with respect to the axis of symmetry.

7. The exhaust gas cooling device according to claim 1,
wherein
the venturi channel forms a mixing stage My with a volume Vv and in that the mixing chamber forms a mixing stage Mm with a volume Vm, and in that the outlet line forms a mixing stage Ma with a volume Va, wherein for the ratio S1 of Vm to Vv: 25>=S1>=2 and/or
for the ratio S2 of Vm to Va: 25>=S2>=2.

8. The exhaust gas cooling device according to claim 1,
wherein
sound-absorbing means are provided inside the mixing chamber and/or upstream of the venturi assembly.

9. The exhaust gas cooling device according to claim 1,
wherein
further vortexing or deflection means are provided inside the mixing chamber.

10. The exhaust gas cooling device according to claim 1,
wherein
upstream of the inlet opening for ambient air a baffle is provided for trapping ambient air.

11. The exhaust gas cooling device according to claim 1,
wherein
a bypass arrangement with a bypass line is provided.

12. The exhaust gas cooling device according to claim 1,
wherein
the venturi channel and the outlet line with the inflow opening open into the same mixing chamber of the housing.

13. The exhaust gas cooling device according to claim 1,
wherein
the mixing chamber is free of partition walls or housing partition walls.

14. The exhaust gas cooling device according to claim 1,
wherein
the inlet opening is coupled to the environment via an ambient air channel and an ambient air inlet guided through the housing, wherein the ambient air inlet is aligned in radial direction to the axis of symmetry.
